(19) United States
(12) Patent Application Publication
(10) Pub. No.: US 2025/0292132 A1
(43) Pub. Date: Sep. 18, 2025

(54) METHOD FOR SELECTING PAIRS OF ENERGY LEVELS FOR A QUBIT

(71) Applicant: OXFORD IONICS LIMITED, Kidlington (GB)

(72) Inventors: Ana SOTIROVA, Oxford (GB); Chris BALLANCE, Oxford (GB); Maciej MALINOWSKI, Obergengstringen (CH); David ALLCOCK, Eugene, OR (US)

(21) Appl. No.: 18/431,432

(22) Filed: Feb. 2, 2024

(51) Int. Cl. G06N 10/40; G06N 10/20; G06N 10/70

(52) U.S. Cl. CPC G06N 10/40; G06N 10/20; G06N 10/70

(57) ABSTRACT

A computer implemented method (200) comprising selecting one or more pairs of energy levels of an isotope of an ion for a qubit for a quantum computer, wherein each of the one or more pairs of energy levels comprises a first metastable state and a second metastable state.

### TECHNICAL FIELD

The present disclosure relates to a computer implemented method for selecting states for qubits and in particular to a computer implemented method for selecting one or more pairs of energy levels of an isotope of an ion for a qubit for a quantum computer.

### BACKGROUND

A trapped ion system may be used to encode a qubit. A qubit is the fundamental unit of information used in quantum computing.

The qubit comprises a pair of atomic states, a first state and a second state and the qubit can exist as a superposition of these two states. The qubit is encoded with the first state and the second state through the trapped ion system. Encoding, in this context, refers to the process of setting the first state and the second state of the qubit.

The states that the qubit is encoded with affects the performance of the quantum computer. Therefore, it is beneficial to identify and select energy levels that have optimized properties in order to improve the performance of the quantum computer.

It should be noted that the term “state” and “energy level” may be used interchangeably. For example, an ion may be in a specific quantum state which has an associated energy level, and where the energy levels are quantised.

### SUMMARY

It is desirable to provide a method for identification and selection of energy levels that have optimized properties for ion trap qubits, in order to improve the performance of quantum computers using ion traps.

According to a first aspect of the disclosure there is provided a computer implemented method comprising selecting one or more pairs of energy levels of an isotope of an ion for a qubit for a quantum computer, wherein each of the one or more pairs of energy levels comprises a first metastable state and a second metastable state.

Optionally, the qubit is approximately magnetic field insensitive.

Optionally, the first and second metastable states comprise a D_{3/2} state or a D_{5/2} state.

Optionally, the first and second metastable states are hyperfine states.

Optionally, the ion is a barium ion.

Optionally, the method comprises generating a list of a plurality of pairs of energy levels of the isotope of the ion, wherein each pair of energy levels has a qubit frequency.

Optionally, the method comprises calculating a magnetic field strength where the qubit frequency is first order insensitive to the magnetic field, for each pair of energy levels in the list.

Optionally, the method comprises discarding, from the list, the pairs of energy levels where the magnetic field strength where the qubit frequency is first order insensitive to the magnetic field has a value outside a magnetic field range.

Optionally, the method comprises calculating the qubit frequency, for each pair of energy levels on the list.

Optionally, the method comprises calculating a transition dipole matrix element, and discarding, from the list, the pairs of energy levels where the transition dipole matrix element is less than a threshold transition dipole matrix element value.

Optionally, the method comprises selecting one or more pairs of energy levels for the qubit from the list based on the qubit frequency.

Optionally, the method comprises calculating a transition matrix element, for each pair of energy levels on the list.

Optionally, the method comprises selecting one or more pairs of energy levels for the qubit from the list where, for each selected pair, the transition matrix element exceeds a threshold transition matrix element value.

Optionally, the method comprises calculating a second order qubit frequency sensitivity to the magnetic field, for each pair of energy levels on the list.

Optionally, the method comprises calculating off resonant shifts, for each pair of energy levels on the list.

Optionally, calculating off resonant shifts comprises calculating off resonant shifts from microwave fields.

Optionally, the method comprises selecting one or more pairs of energy levels for the qubit from the list where, for each selected pair, at least one of the off resonant shifts is less than a threshold off resonant shift value.

Optionally, the method comprises selecting one or more pairs of energy levels for the qubit from the list where, for each selected pair, a ratio of one of the off resonant shifts and the transition matrix element is one of greater than a threshold ratio value, equal to the threshold ratio value, or less than the threshold ratio value.

Optionally, the method comprises performing a gate simulation for each pair of energy levels on the list to determine a simulated error for a fixed noise model, selecting one or more energy levels for the qubit from the list, where for each selected pair, the simulated error is less than an error threshold value.

According to a second aspect of the disclosure there is provided a computer system comprising a module configured as a qubit selection tool configured to perform the method of the first aspect.

It will be appreciated that the computer system of the second aspect may include features set out in the first aspect and can incorporate other features as described herein.

According to a third aspect of the disclosure there is provided a trapped ion system for quantum computing configured to encode a qubit in one of the pairs of energy levels as selected using the method of any of the first aspect.

It will be appreciated that the trapped ion system of the third aspect may include features set out in the first aspect and/or the second aspect and can incorporate other features as described herein.

### DESCRIPTION OF THE DRAWINGS

The disclosure is described in further detail below by way of example only and with reference to the accompanying drawings, in which:

FIG. 1 is a plot showing the available optical qubit transitions for a 40Ca⁺ ion as known in the art;

FIG. 2(a) is a flow chart of a computer-implemented method for selecting one or more pairs of energy levels for a qubit as per the present disclosure, FIG. 2(b) is a flow chart of a specific embodiment of the method of FIG. 2(a), FIG. 2(c) is a table showing an example list as may be generated by the method of FIG. 2(b), FIG. 2(d) is a flow chart of a specific embodiment of the method of FIG. 2(a), FIG. 2(e) shows the table from FIG. 2(c) updated after a calculation of magnetic field strengths, FIG. 2(f) shows the table from FIG. 2(e) as could be presented to a user, FIG. 2(g) is a flow chart showing a specific embodiment of the method of FIG. 2(d), FIG. 2(h) is a flow chart showing a specific embodiment of the method of FIG. 2(d);

FIG. 3 is a table showing the pairs of metastable hyperfine energy levels for a 133Ba⁺ ion;

FIG. 4 is a table showing the pairs of metastable hyperfine energy levels for a 135Ba⁺ ion;

FIG. 5 is a table showing the pairs of metastable hyperfine energy levels for a 137Ba⁺ ion;

FIG. 6(a) is a diagram of a computer system configured to implement the method of FIG. 2, FIG. 6(b) is a schematic of a trapped ion system for a quantum computer configured to encode a qubit in one of the pairs of energy levels as selected by using the method of FIG. 2; and

FIG. 7 is an example embodiment of a trapped ion system for quantum computing configured to encode a qubit with energy levels selected through the method of FIG. 2.

### DESCRIPTION

Trapped ion systems for quantum computing purposes, in general, comprise of an ion trap in a vacuum chamber, a voltage source coupled to the ion trap, a source of neutral atoms, a source of static magnetic field, a plurality of lasers and a fluorescence detector. The plurality of lasers serve a number of purposes, including the excitation and photoionisation of the neutral atoms into ions and trapping the ions in the ion trap.

The ion may, for example, be one of barium, calcium, beryllium, cadmium or ytterbium. Once the ion is chosen, consideration will then be given to the isotope of the ion to be used. Once the ion and its isotope have been selected consideration is given to the states to be used.

Within the technical field, the same states are typically selected for qubits, without consideration being given to other states that may be better suited for a given application such as quantum computing.

The qubits are often encoded into the ground states of the ionised atom being used, for example a calcium ion, as ground states are the most stable energy states and have a long life-time.

When selecting atoms to be used as qubits for use in quantum computing the field-sensitivity of the energy state should also be considered. Qubits that are field-sensitive are inferior for storing quantum information as the encoded energy states of the qubit will change in response to fluctuations in the magnetic field being applied.

Consideration should also be given whether the qubit should be encoded in the ground state or a metastable state. A metastable state is an energy state of an atom or ion which is of higher energy than the ground state. A metastable state has a sufficiently long lifetime for quantum computing.

The lifetime of a metastable state is much longer than the timescale on which quantum gates and other quantum operations (such as readout) occur. For example, for trapped ions, single quantum operations typically take approximately 100 microseconds. Therefore a metastable state has a lifetime longer than approximately 10 milliseconds.

The selection of an ion and its states for a qubit requires consideration of several factors. For example, when choosing the ion species there can be limitations depending on the availability of lasers at certain operational wavelengths.

In the work of Dave Allcock titled ‘Surface-Electrode Ion Traps for Scalable Quantum Computing’ there is provided an analysis to identify field-insensitive qubits for an isotope of calcium. However, it was found that out of the field-insensitive qubits identified only two of them might be used in the context of quantum computing. It is noted that this point was not elaborated on.

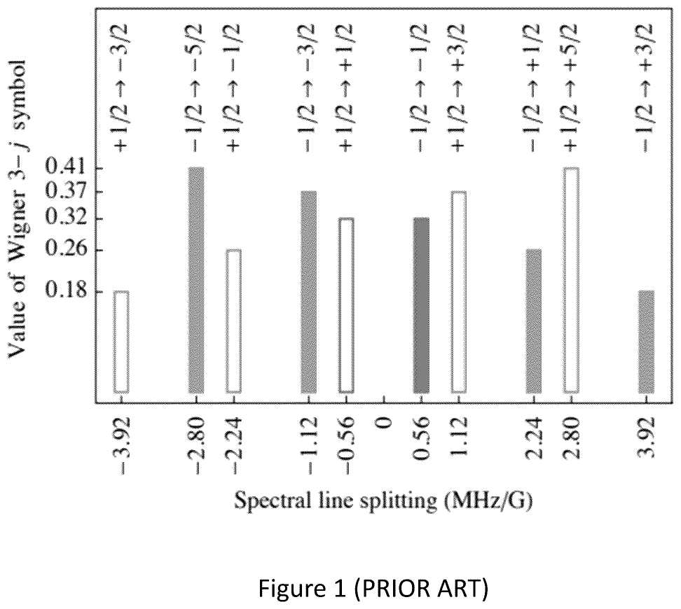

In other work by Florian Leupold ‘Bang-bang Control of a Trapped-Ion Oscillator’ considers the states for optical qubits for an isotope of calcium. Several states from this work are presented in FIG. 1. Each bar represents an optical qubit transition, the longer the bar, the faster the transition and the further the bar is from zero on the x-axis, the increased magnetic field sensitivity of the transition. The work does not explore a method of selecting the best transition out of those identified for quantum computing purposes and the author arbitrarily picks the fastest transition. A disadvantage of these methods is that they do not select between multiple field-independent qubits.

FIG. 1 a plot showing the available optical qubit transitions for a 40Ca⁺ ion that is known in the art. The plot is from the work of Florian Leupold titled ‘Bang-bang Control of a Trapped-Ion Oscillator’, a thesis submitted to attain the degree of Doctor of Sciences of ETH Zurich. In this work, the author was not concerned about qubit decoherence (loss of quantum information) therefore an arbitrary choice out of the available transitions was made without consideration of other factors.

In summary, the present disclosure relates to computer implemented methods of selecting states for qubits, with the states that are selected having been identified as being preferred for quantum computing applications.

Existing methods do not identify the best states for qubits for quantum computing applications, with engineers in the field simply resorting to commonly used energy levels. The methods described herein provide solutions to identify new suitable energy levels with optimized properties.

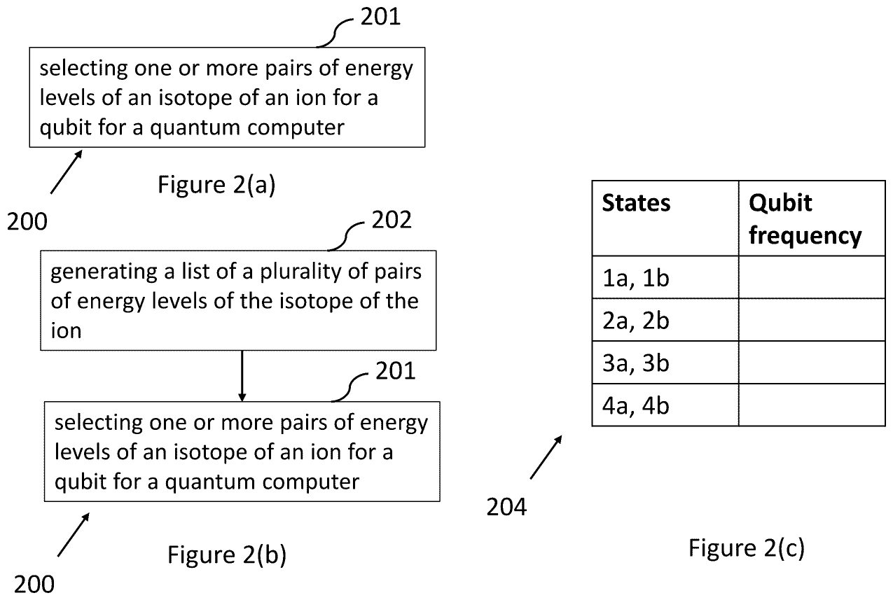

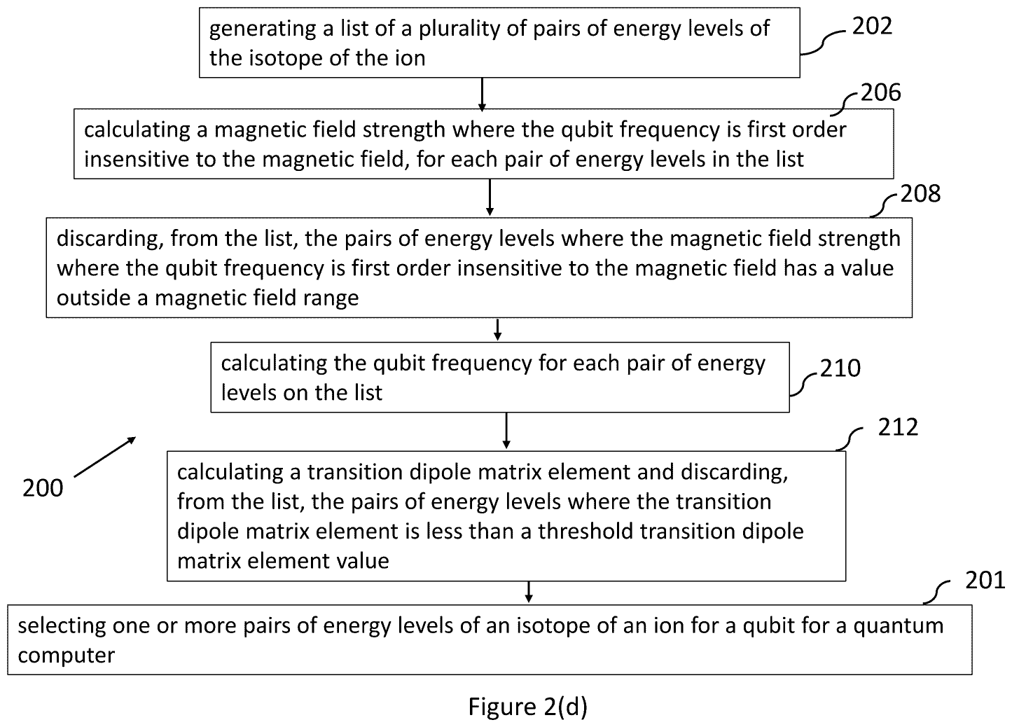

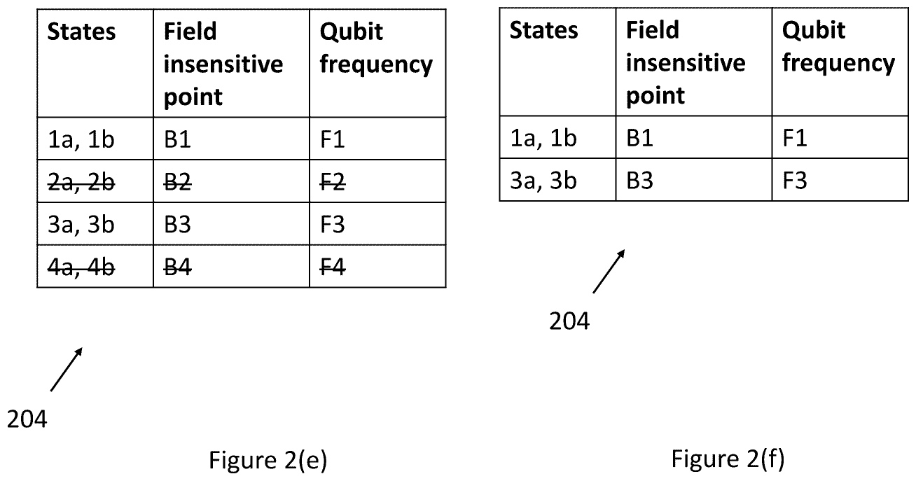

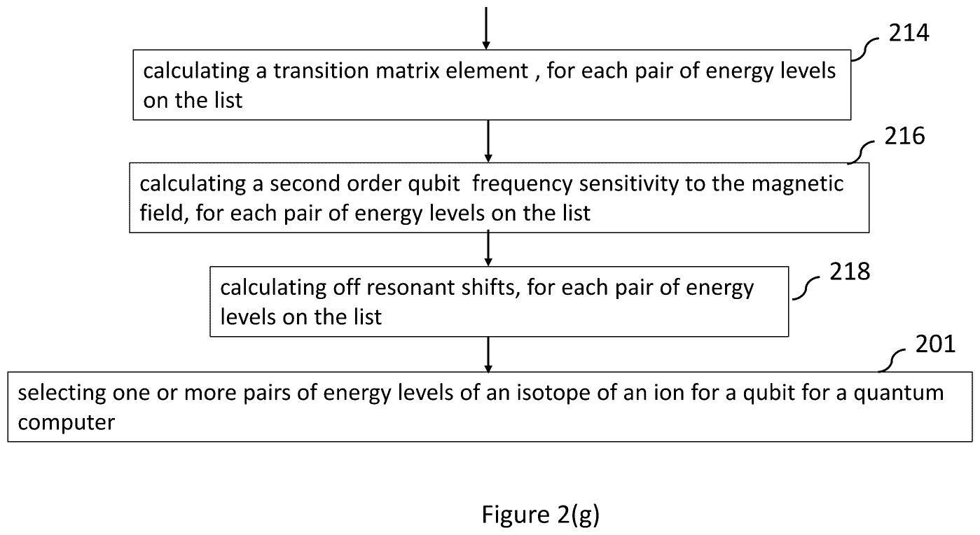

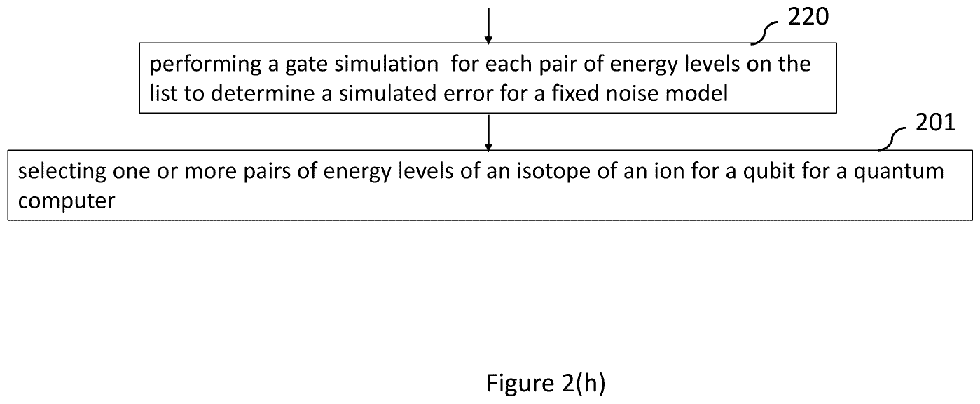

FIG. 2(a) is a flow chart of a computer implemented method 200 comprising selecting one or more pairs of energy levels of an isotope of an ion for a qubit for a quantum computer, at a step 201 in accordance with a first embodiment of the present disclosure. The qubit may be approximately magnetic field insensitive. This means they have a first-order magnetic sensitivity of df(B)/dB approximately equal to 0, where f(B) is a frequency of the qubit which is which is field insensitive at B=B0 and B is the magnetic field. For an ion with an even isotope, the frequency splitting of transitions within a given manifold are: f=gⱼ mⱼ B (df(0)/dB), where gⱼ is the Lande factor, mⱼ is the projection of angular momentum along the quantization axis and B is the magnetic field. The quantity df(0)/dB has a value of 1.4 MHz/Gauss. Every state has a different Lande factor, for example qubits in a D_{5/2} state have a Lande factor of: gⱼ=6/5. Qubits can be encoded in a number of ways in even isotopes and it is found that df (B)/dB=a*1.4 MHz/Gauss where a is a number with a value around 1. For example, optical qubits encoded in 40Ca⁺ can have a value of a anywhere in the range of 0.56 to 3.92.

Therefore, a qubit can be considered to be approximately magnetic field insensitive when its sensitivity to magnetic fields is much lower than qubits encoded in even isotopes. For example, a qubit with df (B)/d(B)<0.1*1.4 MHz/Gauss=140 kHz/G can be considered approximately field insensitive.

Each of the one or more pairs of energy levels comprises a first metastable state and a second metastable state. The first and second metastable states may comprise a D_{3/2} state or a D_{5/2} state. The notation used is the standard atomic physics Lⱼ notation, where L represents the electron orbital angular momentum quantum number and J is the electron total angular momentum quantum number. For each electron orbital, a letter is assigned to represent that orbital. For example, L=0 is assigned the letter S. Therefore, D_{5/2} means L=2 and J=5/2 and D_{3/2} means L=2 and J=3/2. The metastable state D_{5/2} has a life time of approximately 30 seconds. It will be appreciated that the life time may be less than approximately 30 seconds as a result of leakage light. The metastable state D_{3/2} has a life time of approximately 80 seconds. The first and second metastable states may be hyperfine states. The ion may be a barium ion.

FIG. 2(b) is a flow chart of a specific embodiment of the method 200 and comprising generating a list of a plurality of pairs of energy levels of the isotope of the ion, where each pair of energy levels has a qubit frequency, at a step 202. The qubit frequency is defined as the most likely frequency for a photon emitted during the decay of the qubit to have.

For example, for an ion with two atomic states |0> and |1>with respective energies E₀ and E₁ where E₀ is of greater value than E₁, the qubit will have an energy: E=E₀−E₁. Therefore, the qubit frequency will be f_{q}=E/h where h is Planck's constant.

The list of plurality of pairs of energy levels of the isotope of the ion is generate as follows. All the energy levels in a given manifold, for example, the D_{5/2} manifold are listed and only pairs of energy levels where the difference in mF (the projection of the total angular momentum onto the quantisation axis) for each pair is less than 2. If mF changes by more than 1 then the matrix element will be zero. A function that calculates the qubit frequency as well as the first-order magnetic field insensitivity for given states i, j, and magnetic field B is then applied. The qubit frequency calculation function uses atomic physics to calculate atomic energies Ei, Ej and then returns the qubit frequency as f=abs (Ei-Ej)/h, where h is the Plank's constant. A standard optimiser is then run which numerically solves for df (B)/dB=0, and if it finds the solution, returns the B-field where the first-order magnetic field insensitivity occurs, as well as the qubit frequency at this B-field

FIG. 2(c) is a table 204 showing an example list as may be generated in step 202. Each pair of energy levels (for example state 1a and state 1b) has a qubit frequency.

The generated list is a list of a plurality of pairs of energy levels of the isotope of the ion wherein each pair of energy levels has a qubit frequency. Selection, as provided by the step 201, is from the list as generated in step 202, in the present embodiment.

FIG. 2(d) is a flow chart of a specific embodiment of the method 200 and comprising calculating a magnetic field strength where the qubit frequency is first order insensitive to the magnetic field, for each pair of energy levels in the list, at a step 206. A standard optimiser is used to calculate the magnetic field strength where the qubit frequency is first order insensitive. The standard optimiser numerically solves for df (B)/dB=0, and if it finds a solution, the optimiser returns the value of B-field where the first-order magnetic field insensitivity occurs, as well as the qubit frequency at this B-field. The process of finding first order field-insensitive qubits involves calculating the qubit frequency for a large number of magnetic field values, and then using the optimiser to find the one value of the magnetic field where the qubit frequency gradient is zero.

The calculation is performed to find the magnetic field strength at which the qubit frequency is first order insensitive to the magnetic field for each pair of energy levels. This insensitivity to the magnetic field is a significant quantity for qubits used for quantum computing as qubits that are substantially magnetic field insensitive are more efficient at storing quantum information than qubits that are sensitive to magnetic fields. Qubits which are field sensitive will respond to fluctuations in the magnetic field being applied, thereby resulting in loss of information.

FIG. 2(e) shows the table 204 having been updated after calculation of the magnetic field strengths.

The method 200 may further comprise discarding, from the list, the pairs of energy levels where the magnetic field strength where the qubit frequency is first order insensitive to the magnetic field has a value outside a magnetic field range, for example, of 1 Gauss to 1000 Gauss, at a step 208. In other words, for a given pair of energy levels, if their first-order qubit frequency insensitivity is at a magnetic field strength of 2000 Gauss that pair of energy levels will be discarded from the list. A lower value of 1 Gauss may be set as for magnetic fields a lower strength, the transitions out of the energy levels will be overlapped in frequency. This results in an unacceptable level of spectral crowding. The upper value of 1000 Gauss is applied as magnetic fields with a strength higher than this are challenging to generate. Higher magnetic field strengths also add more complexity to ion trapping as they result in a Lorentz force on the moving ions. These limits are not fundamental and different limits can be applied if needed.

The method 200 may further comprise calculating the qubit frequency for each pair of energy levels on the list, at a step 210, and as shown in the table 204 of FIG. 2(d). The qubit frequency calculation function uses atomic physics to calculate atomic energies for each pair of energy levels Ei, Ej and then returns the qubit frequency as f=abs (Ei-Ej)/h, where h is the Plank's constant.

The method 200 may further comprise calculating the transition dipole matrix element and discarding those below a threshold value, for example, 10% of the Bohr magneton at step 212, The speed of quantum operation is directly proportional to the transition dipole matrix element. If the element is low, then the quantum operation is slow. Slow operations are not ideal as they will reduce the quantum computer clock rate and increase the quantum computer error rate.

The discarding is indicated in table 204 of FIG. 2(e) by the strikethrough of some of the states.

Selecting, of one or more pairs of energy levels, as provided by the step 201, may simply be the providing of the table 204 to a user. FIG. 2(f) is an example of the table 204 after step 212 as may be provided to a user. The table 204 may, for example, be presented to the user on a display screen.

In a further embodiment, selecting of the one or more pair of energy levels may be based on the qubit frequency. For example, the table 214 may be further refined, with states having qubit frequencies outside of a range being discarded before results are presented to a user. For example, in order to avoid wave effects, it may be desirable to have pairs of energy levels with a qubit frequency that corresponds to a qubit wavelength longer than the size of the ion trap. For example, if the ion trap has a size of 1 cm then the qubit wavelength will need to be at least 10 cm. Assuming the qubit has a wave speed of v=0.5c (where c is the speed of light), this means the pairs of energy levels selected will need to have a qubit frequency below 1.5 gigahertz. The wave speed of the qubit will depend upon the propagation medium and therefore may vary.

FIG. 2(g) is a flow chart of a specific embodiment of the method 200, and showing the method steps after step 212 as illustrated in FIG. 2(d).

The method 200 comprises calculating a transition matrix element, for each pair of energy levels on the list, at a step 214. The transition matrix element can also be referred to as the magnetic dipole matrix element or the M1 matrix element. This value represents the strength of the of the coupling between the qubit and the external electromagnetic field. If the matrix element has a large value, then the coupling is strong and the quantum gates are much faster. The matrix elements, Rij, are defined so that:

$$R [ i , j ] := {( - 1 )}^{* *} ( q + 1 ) < i \vert u\_q \vert j >$$

$$q := Mi - Mj = ( - 1 , 0 , 1 )$$

u_q is the qth component of the magnetic dipole operator in spherical coordinates.

This method can be applied more broadly. For example, for optical qubits with quadrapole transitions, this calculation would involve calculating the quadrapole matrix elements.

The method 200 may comprise calculating a second order qubit frequency sensitivity to the magnetic field, for each pair of energy levels on the list, at a step 216. The second order qubit frequency is the second order derivative of the first order magnetic field insensitivity: d²f(B)/dB². It is also calculated using a standard optimiser.

The method 200 may comprise calculating off resonant shifts, for example from microwave fields, for each pair of energy levels on the list, at a step 218. When a qubit drive, for example a microwave or a laser, is applied, the qubit frequency is shifted due to the presence of other transitions in the system (off resonant shifts). The amount of off resonant shift is proportional to the power of the applied drive. This is disadvantageous and drive power fluctuations lead to qubit frequency fluctuations which increases the decoherence of the quantum computer. The off-resonant shifts are calculated using the AC Zeeman shift or AC Stark shift formula.

Pairs of energy levels may be selected if they have a transition matrix element exceeding a threshold transition matrix element value, at the step 201. For example, a threshold transition matrix element value could be greater than 0.1 of the Bohr Magneton.

Alternatively, or additionally, pairs of energy levels may be selected if at least one of the off resonant shifts is less than threshold off resonant shift values. Alternatively, or additionally, the selection may be based on a ratio of one of the off resonant shifts and the transition matrix element.

For example, suppose a first transition (transition A) has a matrix element 0.5 muB and an off resonant shift of 100 Hz/μT² and a second transitions (transition B) has a matrix element 0.5 muB and an off resonant shift of 200 Hz/μT². Transition A will be preferable as it has the same matrix element as transition B but a smaller off resonant shift value. Now suppose there is also a third transition (transition C) with a matrix element of 1 muB and an off resonant shift of 150 Hz/μT². Transition C is now preferable because it has an increased matrix element even though it also has an increased off resonant shift.

FIG. 2(h) is a flow chart of a specific embodiment of the method 200, and showing the method steps after step 212 as illustrated in FIG. 2(d).

In the present embodiment the method 200 comprises performing a gate simulation for each pair of energy levels on the list to determine a simulated error for a fixed noise model, at a step 220. Pairs of energy levels may be selected if they have a simulated error that is less than an error threshold value, at the step 201.

For example, a simulation of gate dynamics on a multi-level system may be used. In this case, the atomic Hamiltonian is set to H0=\sum_i \hbar \omega_i |i><i|, where the sum is over all transitions within some range do of the qubit frequency. For the interaction Hamiltonian H1, the Rabi frequencies off all these transitions is added. In other words, for every transition 0<->j, \hbar \Omega M_{0,}(|0><i| +|j><0|) is added, and for every transition 1<->I, \hbar \Omega M_{1,j}(|1><i| +|j><1|) is added, where M_{I,j} is the matrix element of the i< >j transition. The total Hamiltonian H=H0+H1 is simulated by doing the interaction picture with respect to H0 and running a numerical Schroedinger equation solver (such as qutip's in-built mesolve function) to solve for time-evolution of H1. The fidelity of the final state with respect the target state as a function of 2 is then calculated and qubits where this number is sensitive to variations in Q are chosen.

In practice, one can choose many different gates to simulate (single-qubit gates, two-qubit gates etc.), and one would look for sensitivity to the parameter they are most worried about.

Embodiments of the present disclosure, for example as presented in FIGS. 2(a)-(h) allows for filtering and selection of a large number of energy levels across multiple criteria simultaneously.

Example criteria that are addressed by the methods of the present disclosure include: the atomic state lifetime, the qubit frequency, the magnetic field sensitivity, the matrix element, the off-resonant shifts of gate drives, and the proximity to other transitions. Consideration of the proximity to other transitions is to avoid accidental excitations of the qubit during operation of the quantum computer.

Embodiments of the methods of the present disclosure may be used to select one or more pairs of energy levels with a low atomic state lifetime, low magnetic field sensitivity, low off-resonant shifts and higher matrix elements, which will provide lower qubit errors (for example, leakage or decoherence errors) as well as increased speed of the gates. This improves the performance of the quantum computer. Further, if the quantum computer is to be used for a specific function, then embodiments of the methods of the present disclosure can take this into account by setting the desired qubit frequency required for the given implementation.

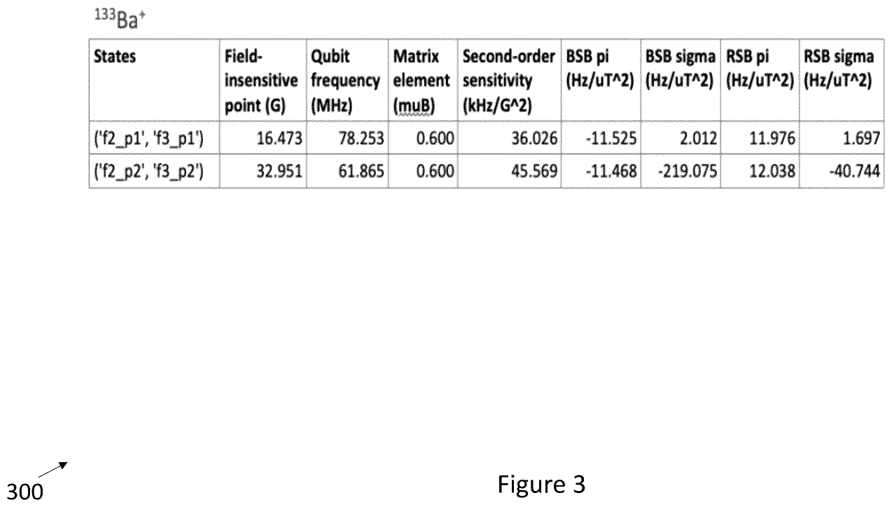

As an example, the embodiment of the method 200 presented in FIG. 2(g) was applied to three ion species of barium: 133Ba⁺, 135Ba⁺ and 137Ba⁺ to produce the tables shown in FIGS. 3, 4 and 5, respectively.

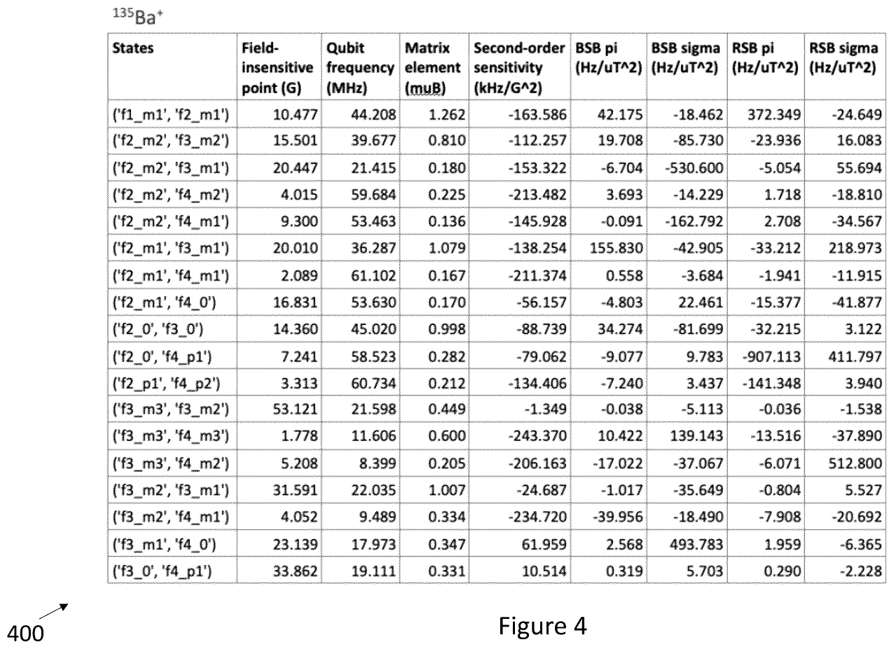

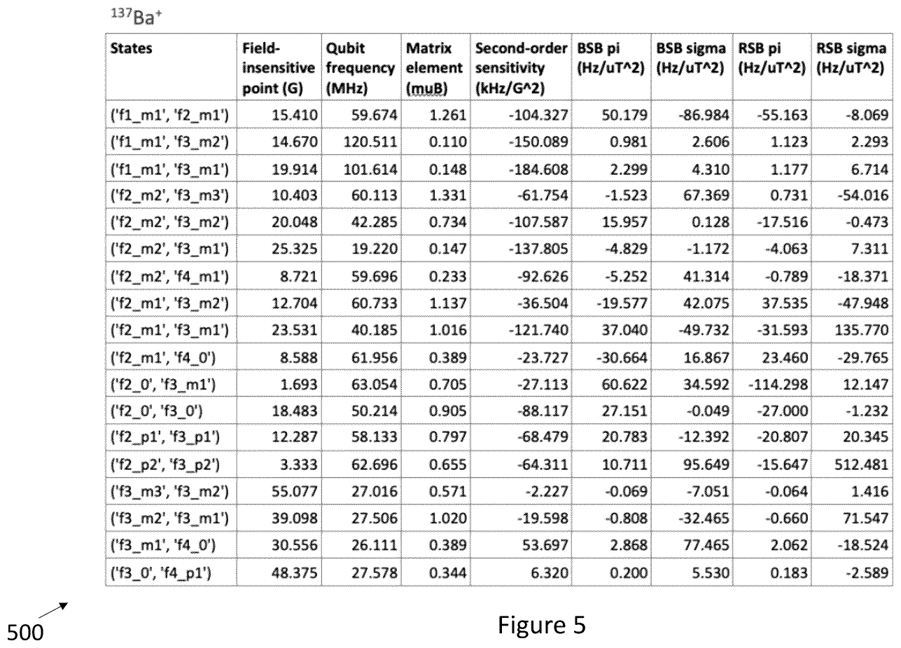

FIG. 3 shows a table 300 listing the pairs of energy levels for 133Ba⁺ barium ion for a qubit for a quantum computer wherein the qubits are magnetic field insensitive. FIG. 4 shows a table 400 listing the pairs of energy levels for 135Ba⁺ barium ion for a qubit for a quantum computer wherein the qubits are magnetic field insensitive. FIG. 5 shows a table 500 listing the pairs of energy levels for 137Ba⁺ barium ion for a qubit for a quantum computer wherein the qubits are magnetic field insensitive.

After the ion species was fixed to Bat, the search space was also fixed to pairs of energy levels with qubit frequency below 1 GHZ, which excludes all the ground-state qubits, leaving just the metastable qubits. The method 200 of FIG. 2(g) was then undertaken for each of the ion species, thereby resulting in the selection of the energy levels pairs as provided by their respective tables.

For every pair of energy levels in the metastable state for 133Ba⁺, 135Ba⁺ and 137Ba⁺ the magnetic field B₀ was calculated. B₀ is the magnetic field strength at which the qubit frequency is first-order insensitive to the magnetic field. Only the pairs of energy levels where B₀ was found to be between 1 Gauss and 1000 Gauss were kept. Afterwards, with the magnetic field fixed to the value of B₀ the qubit frequency, transition matrix element, second-order qubit frequency sensitivity to magnetic field were calculated.

The off-resonant shifts from microwave fields were also calculated. These off-resonant shifts can be used for entangling gates, namely BSB pi, BSB sigma, RSB pi, RSB sigma, assuming a sideband frequency of 3 MHz.

For the 133Ba⁺, 135Ba⁺ and 137Ba⁺ ions, pairs of energy levels were then filtered. Only pairs of energy levels where the qubit frequency was at least 10% the Bohr magneton were kept, as provided by the tables of FIGS. 3, 4, and 5.

The table 300 of pairs of energy levels was generated using the method 200 of FIG. 2(d). The qubits are encoded inside metastable D_{5/2} manifold in 133Ba⁺ Barium isotopes and therefore naturally have long atomic lifetimes and low qubit frequencies. The pairs of energy levels in table 300 are ones where the encoded qubits have first-order magnetic field sensitivity of df/dB=0. In other words, these are the metastable hyperfine energy levels of 133Ba⁺ that are field-insensitive to first order. Table 300 only shows pairs of energy levels where the microwave matrix element it at least 10% of the Bohr magneton. Encoding the qubit with any of the pairs of energy levels from 300 will provide a qubit for quantum computing with improved information storage and performance, when compared with known systems.

The table 400 of pairs of energy levels was generated using the method 200 of FIG. 2(d). The qubits are encoded inside metastable D_{5/2} manifold in 135Ba⁺ Barium isotopes and therefore naturally have long atomic lifetimes and low qubit frequencies. The energy levels in table 400 are ones where the encoded qubits have first-order magnetic field sensitivity of df/dB=0. In other words, these are the metastable hyperfine pairs of energy levels of 135Ba⁺ that are field-insensitive to first order. Table 400 only shows pairs of energy levels where the microwave matrix element it at least 10% of the Bohr magneton. Encoding the qubit with any of the pairs of energy levels from 600 will provide a qubit for quantum computing with improved information storage and performance.

The table 500 of pairs of energy levels was generated using the method 200 of FIG. 2(d). The qubits are encoded inside metastable D_{5/2} manifold in 137Ba⁺ Barium isotopes and therefore naturally have long atomic lifetimes and low qubit frequencies. The pairs of energy levels in table 500 are ones where the encoded qubits have first-order magnetic field sensitivity of df/dB=0. In other words, these are the metastable hyperfine pairs of energy levels of 137Ba⁺ that are field-insensitive to first order. Table 500 only shows pairs of energy levels where the microwave matrix element it at least 10% of the Bohr magneton. Encoding the qubit with any of the pairs of energy levels from 700 will provide a qubit for quantum computing with improved information storage and performance.

The meaning of the data in table 500 is explained below (this applies to the tables 300 and 400). The states column lists a short-hand name for the different pairs of metastable hyperfine energy levels. The way the state names should be read is that “f3_m3” stands for a D_{5/2} manifold state with F=3, mF=−3, while “f2_p1” stands for D_{5/2} manifold state F=1, mF=+1, using the standard atomic physics notation and low-field good quantum numbers F, mF. F represents the total angular momentum and mF is the projection of the angular momentum onto the quantisation axis. The field-insensitive point column lists the magnetic field strength at which the qubit encoded with that pairs of energy levels should be operated at. The matrix element column larger the better. The second-order sensitivity the lower the better. The BSB pi, BSB sigma, RSB pi, RSB sigma columns give a measure of off-resonant shifts from spectator transitions—the lower the better. Explicitly, BSB pi=x Hz/μT∧2 means that if we apply a pi-polarised magnetic field detuned by +3 MHz from the qubit transition of magnitude y uT, the resulting off-resonant qubit frequency shift is given by x*y*y Hz.

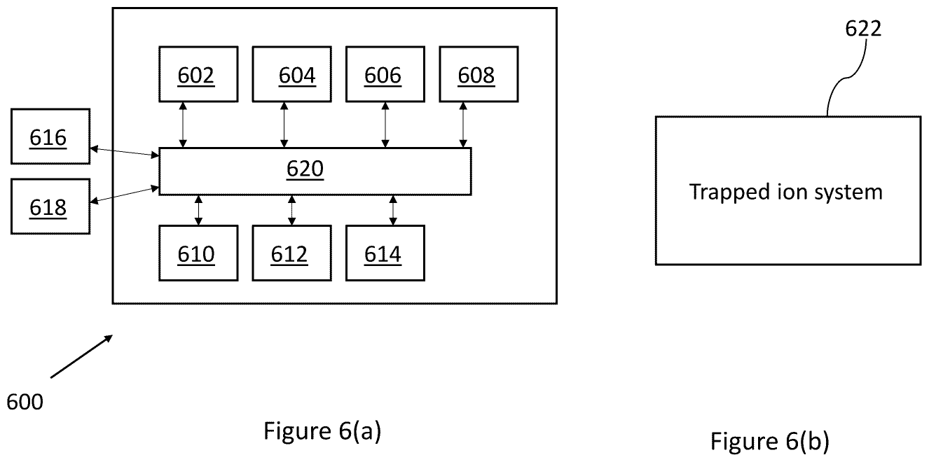

FIG. 6(a) depicts a computer system 600 which comprises specially modified components for carrying out the methods of the present disclosure. The computer system 600 comprises a module 602 which is configured as an qubit selection tool in accordance with a second embodiment of the present disclosure. The method 200 may be run using the qubit selection tool.

The computer system 600 may comprise a processor 604, a storage device 606, RAM 608, ROM 610, a data interface 612, a communications interface 614, a display 616, and an input device 618. The computer system 600 may comprise a bus 620 to enable communication between the different components.

The computer system 600 may be configured to load an application. The instructions provided by the application may be carried out by the processor 600. The application may be the qubit selection tool.

A user may interact with the computer system 600 using the display 616 and the input device 618 to instruct the computer system 600 to implement the methods of the present disclosure in the selection of qubits for quantum computing applications.

The computer system 600 may undertake the method 200, then provide an output, for example on the display 616 of the selected one or more pairs of energy levels.

FIG. 6(b) is a schematic of a trapped ion system 622 for a quantum computer configured to encode a qubit in one of the pairs of energy levels as selected using the method 200, and in accordance with a third embodiment of the present disclosure.

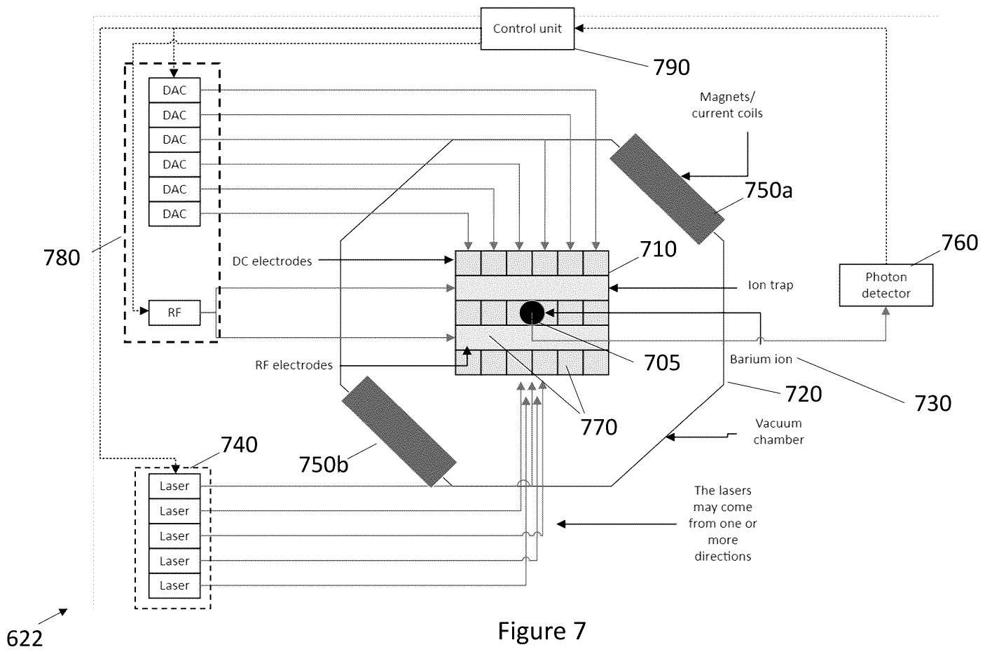

FIG. 7 is a schematic of an example embodiment of the trapped ion system 622 for quantum computing configured to encode a qubit in one of the pairs of energy levels as selected using the method 200. The trapped ion system 622 comprises a trapped ion 705, an ion trap 710, a vacuum chamber 720, an ion source 730, a laser array 740 and a magnetic field source 650a and 650b. The trapped ion system 622 further comprises a fluorescence detector 760, electrodes 770 and a voltage source 780.

The trapped ion system 622 may further comprise a control unit 790. In operation, the control unit 790 receives a signal from the fluorescence detector 760 that includes information on one or more characteristics of the ion 705 as acquired by the fluorescence detector 760. The control unit 790 then provides a control signal to the voltage source 780 which controls the output of the voltage source based on the measured characteristic, or characteristics.

The ion trap 710 is configured to trap a barium ion (being the ion 705) and is situated within the vacuum chamber 720. The ion trap 710 comprises electrodes 770, which couple the ion trap 710 to the voltage source 780. The electrodes 770 in the example trapped ion system 622 of the present disclosure comprise of two types of electrodes: RF electrodes and DC electrodes. However, other electrodes and electrode configurations could also be used.

The iron trap 622 is also coupled with the ion source 730 which is configured to provide the ion 705 to the ion trap 710. In the example embodiment of FIG. 7, the type of ions provided by the ion source 730 are barium ions. The barium ion source 730 comprises a neutral atom source to provide the neutral barium atom and an ionisation device configured to ionize the barium atom and hence provide the barium ion. The neutral atom source and ionisation device are not shown in the figure. The neutral atom source could be, for example, a resistively heated atomic oven or an ablation target. The ionisation device could be, for example, a network of lasers of various operational wavelengths.

The lasers 740 are configured to encode the qubit in one of the pairs of energy levels as selected using the method 200 by applying a first signal at a first frequency to the barium.

The first frequency is associated with a qubit frequency of the first and second metastable hyperfine energy levels. The first signal can be applied, for example, by using a current carrying antenna or a pair of Raman lasers. In the context of the present disclosure, a qubit is a unit of information that comprises a pair of atomic energy levels, a first energy level and a second energy level. The qubit can exist as a superposition of these two energy levels. Encoding the qubit refers to the process of setting the first energy level and the second energy level. In the present disclosure, the qubit is encoded with one of the pairs of energy levels as selected by the method 200. This could be one of the metastable hyperfine pairs of energy levels shown in tables 300, 400 or 500. A metastable energy level is a stable energy level of the barium ion which is of higher energy than the ground energy level and has a long life-time before it will transition towards a more stable energy level. An example of a metastable level is the D_{5/2} energy level. Hyperfine refers to the detailed splitting of the energy levels due to the interaction of the magnetic moments of the nucleus and the electrons in the barium ion.

The magnetic field source 750a and 750b is configured to apply a magnetic field to the ion 705. The strength of the magnetic field applied is at approximately a field insensitive point for the chosen metastable hyperfine energy levels of the barium ion that the qubit has been encoded with.

The trapped ion system 622 encodes qubits with one of the pairs of energy levels as selected using the method 200. These energy levels provide a number of properties which are required for an improved quantum computer. They have long atomic energy level lifetimes, low qubit frequencies, low magnetic field insensitivity, large matrix elements, low frequency crowding and low off-resonant shifts from spectator transitions.

In summary, the present disclosure relates to computer implemented methods of selecting states for qubits, with the states that are selected having been identified as having desirable properties for quantum computing applications.

The methods are implemented in a computer system, for example as shown in FIG. 6(a), and may be used to create an improved trapped ion system, for example as shown in FIG. 6(b), by using energy levels identified as having preferred properties for quantum computer applications. This overcomes issues with known methods, where an engineer will simply resort to commonly used energy levels for a given application.

Various improvements and modifications may be made to the above without departing from the scope of the disclosure.

1. A computer implemented method comprising selecting one or more pairs of energy levels of an isotope of an ion for a qubit for a quantum computer, wherein each of the one or more pairs of energy levels comprises a first metastable state and a second metastable state.

2. The computer implemented method of claim 1, wherein the qubit is approximately magnetic field insensitive.

3. The computer implemented method of claim 1 or 2, wherein the first and second metastable states comprise a D_{3/2} state or a D_{5/2} state.

4. The computer implemented method of claim 1, wherein the first and second metastable states are hyperfine states.

5. The computer implemented method of claim 1, wherein the ion is a barium ion.

6. The computer implemented method of claim 1, comprising:
generating a list of a plurality of pairs of energy levels of the isotope of the ion, wherein each pair of energy levels has a qubit frequency.

7. The computer implemented method of claim 6 comprising:
calculating a magnetic field strength where the qubit frequency is first order insensitive to the magnetic field, for each pair of energy levels in the list.

8. The computer implemented method of claim 7 comprising:
discarding, from the list, the pairs of energy levels where the magnetic field strength where the qubit frequency is first order insensitive to the magnetic field has a value outside a magnetic field range.

9. The computer implemented method of claim 7 comprising:
calculating the qubit frequency, for each pair of energy levels on the list.

10. The computer implemented method of claim 9 comprising:
calculating a transition dipole matrix element; and
discarding, from the list, the pairs of energy levels where the transition dipole matrix element is less than a threshold transition dipole matrix element value.

11. The computer implemented method of claim 9 comprises selecting one or more pairs of energy levels for the qubit from the list based on the qubit frequency.

12. The computer implemented method of claim 9 comprising:
calculating a transition matrix element, for each pair of energy levels on the list.

13. The computer implemented method of claim 12 comprising selecting one or more pairs of energy levels for the qubit from the list where, for each selected pair, the transition matrix element exceeds a threshold transition matrix element value.

14. The computer implemented method of claim 12 comprising:
calculating a second order qubit frequency sensitivity to the magnetic field, for each pair of energy levels on the list.

15. The computer implemented method of claim 14 comprising:
calculating off resonant shifts, for each pair of energy levels on the list.

16. The computer implemented method of 15, wherein calculating off resonant shifts comprises calculating off resonant shifts from microwave fields.

17. The computer implemented method of claim 15 comprising selecting one or more pairs of energy levels for the qubit from the list where, for each selected pair, at least one of the off resonant shifts is less than a threshold off resonant shift value.

18. The computer implemented method of claim 15 comprising selecting one or more pairs of energy levels for the qubit from the list where, for each selected pair, a ratio of one of the off resonant shifts and the transition matrix element is one of:
greater than a threshold ratio value;
equal to the threshold ratio value; or
less than the threshold ratio value.

19. The computer implemented method of claim 9 comprising:
performing a gate simulation for each pair of energy levels on the list to determine a simulated error for a fixed noise model;
selecting one or more energy levels for the qubit from the list, where for each selected pair, the simulated error is less than an error threshold value.

20. A computer system comprising a module configured as a qubit selection tool configured to perform the method of claim 1.

21. A trapped ion system for quantum computing configured to encode a qubit in one of the pairs of energy levels as selected using the method of claim 1.
